(19) United States
(12) Patent Application Publication
(10) Pub. No.: US 2026/0043367 A1
(43) Pub. Date: Feb. 12, 2026

(54) METHODS AND SYSTEMS TO COMPENSATE FOR OXYGEN SENSOR BIAS

(71) Applicant: Ford Global Technologies, LLC, Dearborn, MI (US)

(72) Inventors: Rani Kiwan, West Bloomfield, MI (US); Stephen W. Magner, Farmington Hills, MI (US); Chris Paul Glugla, Macomb, MI (US); Michael Uhrich, Wixom, MI (US)

(21) Appl. No.: 18/801,055

(22) Filed: Aug. 12, 2024

(51) Int. Cl. F02D 41/14; F02D 41/22

(52) U.S. Cl. CPC F02D 41/1495; F02D 41/1441; F02D 41/1454; F02D 41/222

(57) ABSTRACT

Systems and methods for controlling fuel that is supplied to cylinders of an internal combustion engine are described. In one example, oxygen sensors are placed in an exhaust system of an engine such that each oxygen sensor may detect exhaust gas from a pair of engine cylinders. The oxygen sensors may then provide feedback to coupled and decoupled fuel controllers.

### FIELD

The present description relates to a system and methods for controlling fuel supplied to cylinders of an internal combustion engine. The methods and systems may be particularly beneficial to systems that include oxygen sensors.

### BACKGROUND AND SUMMARY

An internal combustion engine may operate with a closed-loop fuel control system that includes oxygen sensors. The oxygen sensors may be positioned upstream and downstream of a catalyst. The upstream sensors may provide feedback that is indicative of combustion in engine cylinders. The downstream sensors may provide feedback that is indicative of conditions within or downstream of a catalyst. The upstream and downstream oxygen sensors may be used together to control fuel that is supplied to engine cylinders. However, oxygen sensors may be subject to bias and the bias may affect engine emissions.

The inventors herein have recognized the above-mentioned disadvantages and have developed a method for operating an engine, comprising: via a controller, adjusting operation of an inner-loop delta fuel controller in response to an indication of oxygen sensor bias; and injecting fuel to the engine in response to output of the inner-loop delta fuel controller.

By adjusting operation of the inner-loop delta fuel controller, it may be possible to provide the technical result of reducing air-fuel ratio imbalances between two pairs of cylinders that may be induced via an oxygen sensor when the oxygen sensor is biased. Adjusting operation of the inner-loop controller may include deactivating the inner-loop controller or constraining the range of authority of the inner-loop controller.

The present description may provide several advantages. In particular, the approach may lower engine emissions via a delta fuel controller when oxygen sensors are not experiencing bias. Further, the approach may constrain engine emissions when oxygen sensor bias may be present. Additionally, the approach may adjust operation of the delta fuel controller if there is an indication that an oxygen sensor may be sensing gases from a cylinder that is not intended to be monitored by the oxygen sensor.

The above advantages and other advantages, and features of the present description will be readily apparent from the following Detailed Description when taken alone or in connection with the accompanying drawings.

It may be understood that the summary above is provided to introduce in simplified form a selection of concepts that are further described in the detailed description. It is not meant to identify key features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The advantages described herein will be more fully understood by reading an example of an embodiment, referred to herein as the Detailed Description, when taken alone or with reference to the drawings, where:

FIG. 1 is a schematic diagram of a single cylinder of an engine;

FIG. 2 is a schematic diagram of an eight-cylinder engine with an illustration of an air-fuel ratio control system;

FIG. 3 is a schematic diagram that illustrates a fuel controller having an inner control loop and an outer control loop; and

FIG. 4 is a flowchart for operating a fuel control system that includes a delta fuel controller.

### DETAILED DESCRIPTION

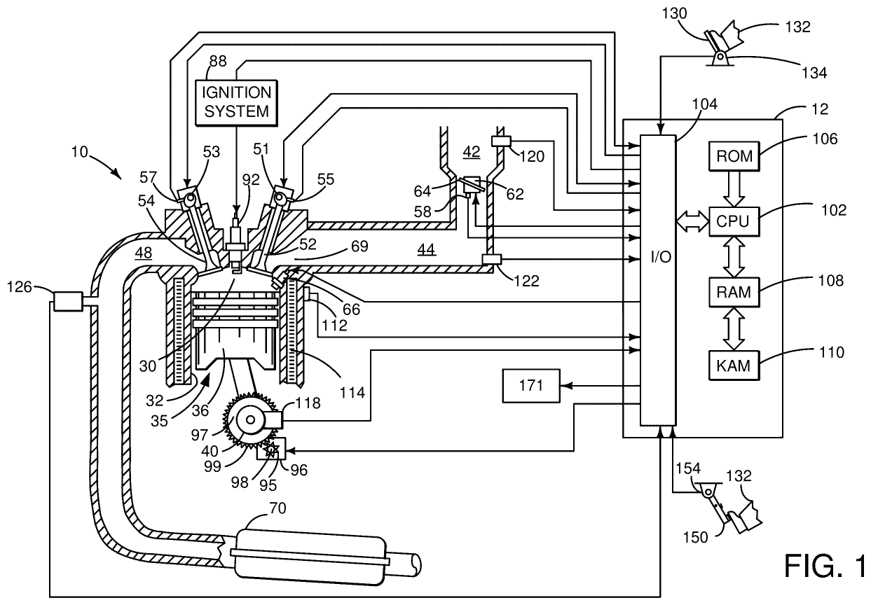

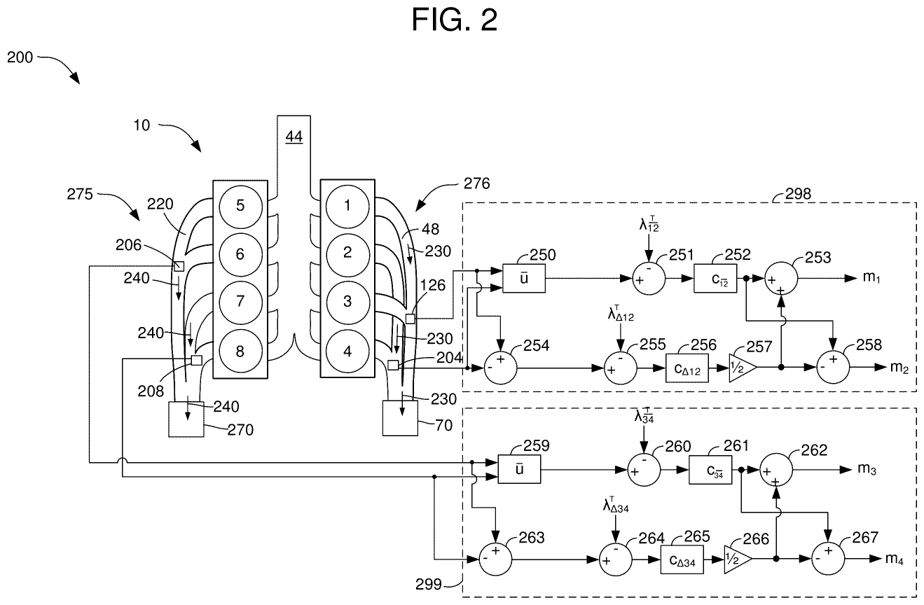

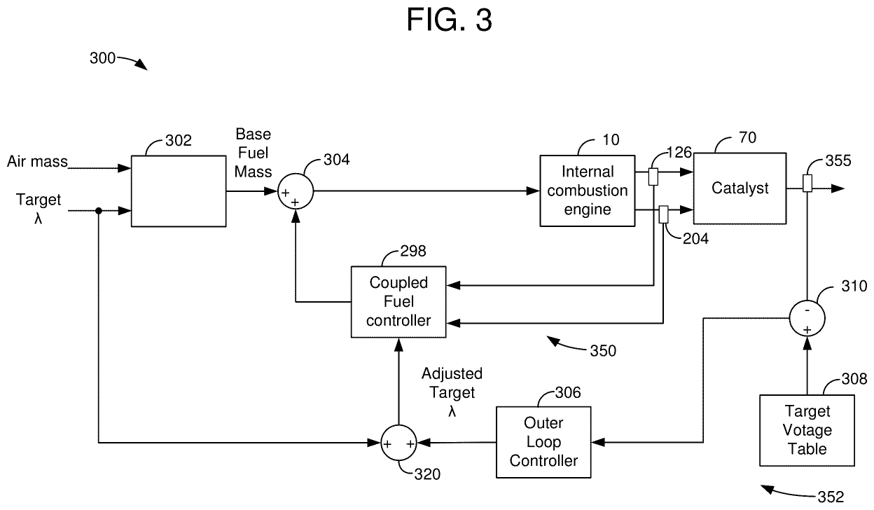

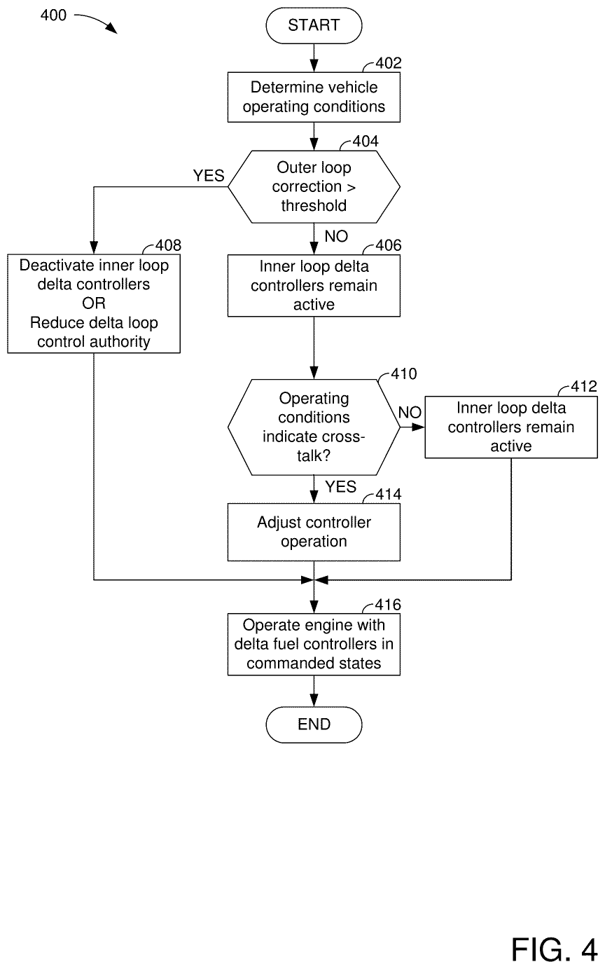

The present description is related to enabling and constraining operation of a delta fuel control system. The delta fuel control system may include four upstream oxygen sensors (e.g., four oxygen sensors in an exhaust system upstream of catalysts). A single cylinder of an internal combustion engine as shown in FIG. 1. An example, engine and fuel control system is shown in FIG. 2. A block diagram of a fuel control system that includes an inner control loop and an outer control loop is shown in FIG. 3. A flowchart of a method for operating an engine that includes a delta fuel controller is shown in FIG. 4.

Referring to FIG. 1, internal combustion engine 10, comprising a plurality of cylinders, one cylinder of which is shown in FIG. 1, is controlled by electronic engine controller 12. Engine 10 includes combustion chamber 30 and cylinder walls 32 with piston 36 positioned therein and connected to crankshaft 40. Flywheel 97 and ring gear 99 are coupled to crankshaft 40. Starter 96 includes pinion shaft 98 and pinion gear 95. Pinion shaft 98 may selectively advance pinion gear 95 to engage ring gear 99. Starter 96 may be directly mounted to the front of the engine or the rear of the engine. In some examples, starter 96 may selectively supply torque to crankshaft 40 via a chain. In one example, starter 96 is in a base state when not engaged to the engine crankshaft. Combustion chamber 30 is shown communicating with intake manifold 44 and exhaust manifold 48 via respective intake valve 52 and exhaust valve 54. Each intake and exhaust valve may be operated by an intake cam 51 and an exhaust cam 53. The position of intake cam 51 may be determined by intake cam sensor 55. The position of exhaust cam 53 may be determined by exhaust cam sensor 57.

Direct fuel injector 66 is shown positioned to inject fuel directly into cylinder 35, which is known to those skilled in the art as direct injection. Fuel injector 66 delivers liquid fuel in proportion to a voltage pulse width or fuel injector pulse width of a signal from controller 12. Fuel is delivered to fuel injector 66 by a fuel system (not shown) including a fuel tank, fuel pump, and fuel rail (not shown). In addition, intake manifold 44 is shown communicating with optional electronic throttle 62 which adjusts a position of throttle plate 64 to control air flow from air intake 42 to intake manifold 44. In some examples, throttle 62 and throttle plate 64 may be positioned between intake valve 52 and intake manifold 44 such that throttle 62 is a port throttle.

Distributorless ignition system 88 provides an ignition spark to combustion chamber 30 via spark plug 92 in response to controller 12. First oxygen sensor 126 (e.g., universal Exhaust Gas Oxygen (UEGO) sensor, which may be referred to as a wide-band oxygen sensor) is shown coupled to exhaust manifold 48 upstream of catalytic converter 70. Alternatively, a two-state (e.g., narrow band) exhaust gas oxygen sensor may be substituted for first oxygen sensor 126.

Catalytic converter 70 can include multiple catalyst bricks, in one example. In another example, multiple emission control devices, each with multiple bricks, can be used. Catalytic converter 70 can be a three-way type catalyst in one example.

Controller 12 is shown in FIG. 1 as a conventional microcomputer including: microprocessor unit 102, input/output ports 104, read-exclusive memory 106 (e.g., non-transitory memory), random access memory 108, keep alive memory 110, and a conventional data bus. Controller 12 is shown receiving various signals from sensors coupled to engine 10, in addition to those signals previously discussed, including: engine coolant temperature (ECT) from temperature sensor 112 coupled to cooling sleeve 114; a position sensor 134 coupled to a driver demand pedal 130 for sensing a distance displaced by human 132; a position sensor 154 coupled to caliper application pedal 150 for sensing distance displaced by human 132, a measurement of engine manifold pressure (MAP) from pressure sensor 122 coupled to intake manifold 44; an engine position sensor 118 that senses a position of crankshaft 40; a measurement of air mass entering the engine from sensor 120; and a measurement of throttle position from sensor 58. Barometric pressure may also be sensed (sensor not shown) for processing by controller 12. In a preferred aspect of the present description, engine position sensor 118 produces a predetermined number of equally spaced pulses each revolution of the crankshaft from which engine speed (RPM) can be determined.

In some examples, the engine may be coupled to an electric motor/battery system in a hybrid vehicle. Further, in some examples, other engine configurations may be employed, for example a diesel engine with multiple fuel injectors. Further, controller 12 may receive input and communicate conditions such as degradation of components to light, or alternatively, human/machine interface 171.

During operation, each cylinder within engine 10 typically undergoes a four stroke cycle: the cycle includes the intake stroke, compression stroke, expansion stroke, and exhaust stroke. During the intake stroke, generally, the exhaust valve 54 closes and intake valve 52 opens. Air is introduced into combustion chamber 30 via intake manifold 44, and piston 36 moves to the bottom of the cylinder so as to increase the volume within combustion chamber 30. The position at which piston 36 is near the bottom of the cylinder and at the end of its stroke (e.g. when combustion chamber 30 is at its largest volume) is typically referred to by those of skill in the art as bottom dead center (BDC). During the compression stroke, intake valve 52 and exhaust valve 54 are closed. Piston 36 moves toward the cylinder head so as to compress the air within combustion chamber 30. The point at which piston 36 is at the end of its stroke and closest to the cylinder head (e.g. when combustion chamber 30 is at its smallest volume) is typically referred to by those of skill in the art as top dead center (TDC). In a process hereinafter referred to as injection, fuel is introduced into the combustion chamber. In a process hereinafter referred to as ignition, the injected fuel is ignited by known ignition means such as spark plug 92, resulting in combustion. During the expansion stroke, the expanding gases push piston 36 back to BDC. Crankshaft 40 converts piston movement into a rotational torque of the rotary shaft. Finally, during the exhaust stroke, the exhaust valve 54 opens to release the combusted air-fuel mixture to exhaust manifold 48 and the piston returns to TDC. Note that the above is shown merely as an example, and that intake and exhaust valve opening and/or closing timings may vary, such as to provide positive or negative valve overlap, late intake valve closing, or various other examples.

Referring now to FIG. 2, a plan view 200 of engine 10 is shown. Engine 10 is the same engine as shown in FIG. 1, but in FIG. 2, all engine cylinders are shown. In this example, the engine's cylinders are numbered 1 through 8. The cylinders are supplied with air via intake manifold 44. A first bank of cylinders includes cylinders 1-4 and a second bank of cylinders includes cylinders 5-8. Cylinders 1-4 are shown in fluidic communication with exhaust manifold 48 and cylinders 5-8 are shown in fluidic communication with exhaust manifold 220. Exhaust system 275 includes exhaust manifold 220 and catalyst 270 processes gases from cylinders 5-8. However, in other examples, an individual catalyst may be provided to process gases for cylinder pair [5,6] and another individual catalyst may be provided to process gases for cylinder pair [7,8]. Exhaust system 276 includes exhaust manifold 48 and catalytic converter 70 processes gases from cylinders 1-4. However, in other examples, an individual catalyst may be provided to process gases for cylinder pair [1,3] and another individual catalyst may be provided to process gases for cylinder pair [2,4]. Each of cylinders 1-8 includes a fuel injector, spark plug, and intake/exhaust valves as shown in FIG. 1.

A first oxygen sensor 126 (e.g., an upstream oxygen sensor (UEGO)) is shown configured to sense exhaust gases from cylinders numbered 1 and 3. A second oxygen sensor 204 (e.g., an upstream oxygen sensor UEGO)) is shown configured to sense exhaust gases from cylinders 2 and 4. A third oxygen sensor 206 (e.g., an upstream oxygen sensor (UEGO)) is shown configured to sense exhaust gases from cylinders numbered 5 and 6. A fourth oxygen sensor 208 (e.g., an upstream oxygen sensor (UEGO)) is shown configured to sense exhaust gases from cylinders 7 and 8. There are no cylinders that are downstream of any of the exhaust gas sensors according to exhaust flow from the cylinders as indicated by arrows 230 and 240.

Output of first oxygen sensor 126 may be applied as air-fuel or equivalence ratio (e.g., λ=air-fuel ratio/stoichiometric air-fuel ratio) feedback for controlling fuel that is supplied to cylinders numbered 1 and 3. Output of second oxygen sensor 204 may be applied as air-fuel or equivalence ratio feedback for controlling fuel that is supplied to cylinders numbered 2 and 4. Output of third oxygen sensor 206 may be applied as air-fuel or equivalence ratio feedback for controlling fuel that is supplied to cylinders numbered 5 and 6. Output of fourth oxygen sensor 208 may be applied as air-fuel or equivalence ratio feedback for controlling fuel that is supplied to cylinders numbered 7 and 8.

FIG. 2 also illustrates two coupled cylinder bank equivalence ratio controllers, or alternatively, coupled cylinder bank fuel controllers 298 and 299, for the eight-cylinder engine with four upstream oxygen sensors. The coupled cylinder bank fuel controller 298 includes controller C_{1̅2̅} 252 and controller C_{Δ12} 256. Coupled cylinder bank fuel controller 299 includes controller C_{3̅4̅} 261 and controller C_{Δ34} 265. These controllers may be proportional/integral controllers, proportional/integral/derivative controllers, Smith predictor, linear controllers, or non-linear controllers that may also include adaptive learning. These fuel controllers as well as the difference or summing junctions (e.g., 251), halving blocks (e.g., 266), and average functions (e.g., 250) may be incorporated as executable instructions stored in non-transitory memory of a controller as part of a method.

Controller C_{1̅2̅} 252 controls the average fueling of a first pair of cylinders [1,3] and a second pair of cylinders [2,4] according to an average of two oxygen sensor derived lambda values determined at block 250 (e.g., where

$$\overline{u} = \frac{{λ}_{1} + {λ}_{2}}{2} ,$$

where λ₁ is a lambda value derived from the output of first oxygen sensor 126, and where λ₂ is a lambda value derived from the output of second oxygen sensor 204) and a difference between the averaged oxygen sensor output derived lambda (ū) and a target average lambda for the first and second cylinder pairs

$$( {λ}_{\overline{12}}^{T} )$$

as determined at difference or summing junction 251.

Controller C_{Δ12} 256 controls delta or difference fueling for a first pair of cylinders [1,3] and a second pair of cylinders [2,4] according to a difference of two oxygen sensor derived lambda values determined at summing junction 254 (e.g., where output of summing junction 254 is δ=λ₁−λ₂) and a difference between the delta lambda of the first and second pairs of cylinders (δ) and a target difference lambda for the first and second cylinder pairs

$$( {λ}_{Δ12}^{T} )$$

as determined as difference or summing junction 255 (e.g., where output of summing junction 255 is

$$( δ - {λ}_{Δ12}^{T} ) .$$

The output of controller C_{Δ12} is multiplied by ½ at block 257. The output of block 257 is added to the output of block 252 (output of controller C_{\vec{12}}) at summing junction 253 to generate a fuel mass modification (m₁) value to the first pair of cylinders. The output of block 257 is subtracted from the output of block 252 (output of controller C_{\vec{12}}) at summing junction 258 to generate a fuel mass modification (m₂) value to the second pair of cylinders.

Controller C_{3̅4̅} 261 controls the average fueling of a third pair of cylinders [5,6] and a fourth pair of cylinders [7,8] according to an average of two oxygen sensor derived lambda values determined at block 259 (e.g., where

$$\overline{u} = \frac{{λ}_{3} + {λ}_{4}}{2} ,$$

where λ₃ is a lambda value derived from the output of third oxygen sensor 240, and where λ₄ is a lambda value derived from the output of fourth oxygen sensor 208) and a difference between the averaged oxygen sensor output derived lambda (ū) and a target average lambda for the third and fourth cylinder pairs

$$( {λ}_{\overline{34}}^{T} )$$

as determined at difference or summing junction 260.

Controller C_{Δ34} 265 controls delta or difference fueling for the third pair of cylinders [5,6] and the fourth pair of cylinders [7,8] according to a difference of two oxygen sensor derived lambda values determined at summing junction 263 (e.g., where output of summing junction 263 is δ=λ₃−λ₄) and a difference between the delta lambda of the third and fourth pairs of cylinders (δ) and a target difference lambda for the third and fourth cylinder pairs

$$( {λ}_{Δ34}^{T} )$$

as determined at difference or summing junction 264 (e.g., where output of summing junction 264 is

$$( δ - {λ}_{Δ34}^{T} ) .$$

The output of controller C_{Δ34} is multiplied by ½ at block 266. The output of block 266 is added to the output of block 261 (output of controller C_{3̅4̅}) at summing junction 262 to generate a fuel mass modification (m₃) value to the third pair of cylinders. The output of block 266 is subtracted from the output of block 261 (output of controller C_{3̅4̅}) at summing junction 267 to generate a fuel mass modification (m₄) value to the fourth pair of cylinders.

Thus, the controllers of FIG. 2 control fuel that is delivered to cylinders to an average lambda value and they also control fuel to reduce a difference in lambda values between cylinder groups. In this example, the left bank of cylinders and the right bank of cylinders may be controlled independently.

Although FIG. 2 is described systems in terms of a V8 engine, it may be appreciated that the approach described herein may be applied to a four-cylinder engine where two oxygen sensors are placed in an exhaust system upstream of a catalyst. The four-cylinder engine may apply uncoupled controllers as shown herein.

Referring now to FIG. 3, a block diagram 300 of a fuel control system that includes an inner control loop 350, which may be referred to as “inner loop” and an outer control loop 352, which may be referred to as “outer loop” is shown. It may be appreciated that FIG. 3 shows a simplified version of a fuel control system that includes inner and outer loops. Other versions of fuel control systems having inner and outer control loops are also anticipated. The fuel control system that is shown in FIG. 3 may be generated via executable instructions that are stored in non-transitory memory of a controller (e.g., 12 of FIG. 1). The fuel control system of FIG. 3 may be applied to control fuel that is supplied to one or more engine cylinders. In this example, block diagram 300 pertains to controlling fuel to a first bank of cylinders (e.g., cylinders 1-4 of FIG. 2).

A mass flow rate of air entering the engine and target lambda are input to target fuel mass generator 302. Target fuel mass generator 302 outputs a fuel mass value to summing junction 304. The mass of fuel is based on a mass flow rate of air entering the engine, the number of engine cylinders, stoichiometric air-fuel ratio, and a target lambda value (e.g., lambda=air-fuel ratio/stoichiometric air-fuel ratio). Summing junction 304 outputs a fuel mass value and the fuel mass is injected to engine 10. Engine 10 combusts the injected fuel with the inducted air to generate power and exhaust. The exhaust may be sensed via first oxygen sensor 126 and second oxygen sensor 204. Untreated exhaust may flow into and be treated via catalytic converter 70. Treated exhaust gases may be sensed via downstream oxygen sensor 355 (e.g., a narrow band heated oxygen sensor). Downstream oxygen sensor 355 is located downstream of catalytic converter 70 according to a direction of exhaust flow from engine cylinders to atmosphere.

Outer control loop 352 includes the inner loop (summing junction 304, internal combustion engine 10, oxygen sensors 126 and 204, and coupled controller 298), catalytic converter 70, downstream oxygen sensor 355, summing junction 310, target voltage table 308, outer loop controller 306, and summing junction 320 that adjusts target of the coupled controller 298. Outer loop controller 306 may be a proportional controller, a proportional/integral controller, a proportional/integral/derivative controller, linear controller, non-linear controller, or other known controller. Outer control loop 352 receives a signal (e.g., a voltage) from downstream oxygen sensor 355 and the voltage is subtracted from a target voltage that is received from a target voltage table 308. The target voltage may be output as a function of engine speed and load. Junction 310 outputs a difference or error between the target voltage and the voltage output from the downstream oxygen sensor 355. The outer loop controller 306 receives the voltage error and supplies a correction lambda bias to inner loop controller 298. This bias correction addresses the catalyst offset state which would not be detected by inner loop controller 298 using sensors 126 and 204. The bias correction is added to target lambda at summing junction 320 to provide an adjusted target lambda to inner loop controller 298.

Inner control loop 350 includes summing junction 304, internal combustion engine 10, first oxygen sensor 126, second oxygen sensor 204, and coupled cylinder bank fuel controller 298 (e.g., an inner loop controller). The inner control loop receives signals from first oxygen sensor 126 and second oxygen sensor 204, as well as the adjusted target lambda from summing junction 320. The signals are converted to lambda values and the inner control loop generates fuel masses (e.g., m1 and m2). These masses are added with the base fuel mass at summing junction 304 and a modified or adjusted base fuel mass is delivered to the internal combustion engine 10.

The fuel control system of FIG. 3 is applied to a bank of cylinders and the fuel control system of FIG. 3 includes two oxygen sensors with two inner-loop controllers (e.g., C_{1̅2̅} and C_{Δ12} as shown in FIG. 2). This allows a more refined control of the cylinder lambda values where the average lambda of each subset of two cylinders is controlled to a desired lambda value (e.g., 1) compared to other systems with one UEGO oxygen sensor (one per bank) where the average lambda of each subset of four cylinders is controlled to the desired lambda value. The control system of FIG. 3 may provide more refined fuel control that reduces a nominal cylinder-to-cylinder air-fuel ratio imbalance (e.g., ±5% to ±7% due to part-to-part variation). This reduced air-fuel ratio imbalance may be achieved if the delta fuel controller C_{Δ12} is enabled. However, oxygen sensor biases may introduce an air-fuel ratio imbalance between the same-bank pairs of cylinders (e.g., if first pair oxygen sensor is biased by 1% relative to second pair oxygen sensor, a 1% air-fuel ratio imbalance between first pair and second pair is induced via feedback control). Oxygen sensor biases may introduce an air-fuel ratio imbalance if the delta fuel controller C_{Δ12} is enabled. Since nominal oxygen sensor biases are considerably smaller than nominal cylinder-to-cylinder air-fuel ratio imbalances, enabling the delta fuel controller C_{Δ12} results in a net benefit. Similar conditions apply for a fuel controller for cylinders 5-8.

The systems of FIGS. 1-3 provides for a fuel control system for an internal combustion engine, comprising: a first cylinder bank coupled to an exhaust system that includes a first oxygen sensor upstream of a first catalyst and a second oxygen sensor upstream of the first catalyst; and a controller including executable instructions stored in non-transitory memory that cause the controller to adjust operation of a first delta fuel controller that receives output from the first oxygen sensor and the second oxygen sensor in response to a correction value of a first outer-loop fuel controller exceeding a threshold value. In a first example, the fuel control system includes where adjusting operation of the first delta fuel controller includes deactivating the first delta fuel controller. In a second example that may include the first example, the fuel control system includes where adjusting operation of the first delta fuel controller includes constraining output of the first delta fuel controller to a predetermined range. In a third example that may include one or both of the first and second examples, the fuel control system further comprises a second cylinder bank coupled to the exhaust system, the exhaust system including a third oxygen sensor upstream of a second catalyst and a fourth oxygen sensor upstream of the second catalyst. In a fourth example that may include one or more of the first through third examples, the fuel control system further comprises additional executable instructions stored in non-transitory memory that cause the controller to maintain operation of a second delta fuel controller in response to a correction value of a second outer-loop fuel controller not exceeding the threshold value. In a fifth example that may include one or more of the first through fourth examples, the fuel control system includes where the second delta fuel controller adjusts a fuel mass in response to a difference between lambda determined via the third oxygen sensor and lambda determined via the fourth oxygen sensor. In a sixth example that may include one or more of the first through fifth examples, the fuel control system includes where the first delta fuel controller adjusts a fuel mass in response to a difference between lambda determined via the first oxygen sensor and lambda determined via the second oxygen sensor.

Referring now to FIG. 4, a flowchart of a method for selecting and activating one of two fuel control systems according to vehicle operating conditions is shown. The method of FIG. 4 may be incorporated to the system of FIGS. 1-3 via executable instructions stored in non-transitory memory of a controller. The method of FIG. 4 may be applied to an engine system where pairs of cylinders share a same catalyst for processing gases of the pairs of cylinders.

At 402, method 400 determines operating conditions. Operating conditions may include but are not constrained to engine speed, engine load, ambient air temperature, catalyst temperature, engine temperature, and driver demand load. Method 400 may determine the operating conditions via the sensors described herein. Method 400 proceeds to 404.

At 404, method 400 judges whether or not an outer fuel control loop correction value (e.g., output of outer loop controller 306 in FIG. 3) is greater than a threshold value. If so, the answer is yes and method 400 proceeds to 408. Otherwise, the answer is no and method 400 proceeds to 406. An outer loop correction value that is greater than a threshold may be indicative of upstream oxygen sensor bias or other forms of degradation. Therefore, in other examples, method 400 may judge whether or not one of the upstream oxygen sensors is exhibiting bias or is degraded. If so, the answer is yes and method 400 proceeds to 408. Otherwise, the answer is no and method 400 proceeds to 406.

At 406, method 400 operates inner control loop 350 of the cylinder bank that is being controlled with delta controls and base gains (e.g., proportional gains, integral gains, derivative gains, etc., where the gain values are real numbers) activated. Method 400 proceeds to 410.

At 408, method 400 deactivates inner control loop delta controllers (e.g., 256 of FIG. 2) for the cylinder bank that has the outer control loop with the correction that is greater than a threshold. The delta controller of the other inner control loop for a cylinder bank that does not have an outer loop correction that is greater than the threshold may remain activated. However, if outer control loops for both cylinder banks have correction values that are greater than the thresholds, then inner control loop delta controllers for each cylinder bank may be deactivated. The inner loop delta controller may be deactivated by setting the output of the inner loop delta controller to a value of zero. The average controllers (e.g., 252 of FIG. 2) may remain activated since the outer loop controller may compensate for the oxygen sensor bias when average control is activated.

Alternatively, instead of deactivating inner control loop delta controllers, method 400 may constrain the output authority range of inner control loop delta controllers. The delta controller range of authority (upper & lower thresholds that are not to be crossed or exceeded) for a cylinder bank may be reduced as a function of larger outer-loop correction value for the cylinder bank. Note that the delta controller's range of authority for first and second cylinder banks may be varied independently from one another. For example, the first cylinder bank delta controller range of authority may be set to a maximum of ±15% of the mass of the base amount of fuel injected to the cylinders if the first cylinder bank outer-loop correction is within ±1% of the mass of the base amount of fuel injected, then the delta fuel controller authority may be gradually reduced to ±2% of the mass of the base amount of fuel injected as the outer-loop correction reaches ±3% of the mass of the base amount of fuel injected Method 400 proceeds to 416.

At 410, method 400 judges whether or not operating conditions indicate that there may be exhaust cross-talk such that an exhaust sensor senses exhaust gas from a cylinder that the exhaust sensor is not intended to sense. In one example, according to the oxygen sensors and exhaust systems shown in FIG. 2, cross-talk may occur when exhaust from one or more cylinders passes an upstream oxygen sensor and is sensed by a second upstream oxygen sensor. The exhaust from one or more cylinders may be exposed to two upstream oxygen sensors due to pressure pulsations in the exhaust system that may be reflected back to one of the upstream oxygen sensors. Exhaust gases of a cylinder pair may be exposed to a sole upstream oxygen sensor when cross-talk is not present. The conditions under which cross-talk may occur may be a function of engine speed and engine load.

In one example, vehicle operating conditions where cross-talk may occur may be mapped and stored in controller memory. If the vehicle operates under conditions where mapping indicates cross-talk, method 400 may judge that cross-talk conditions are present. If method 400 judges that cross-talk conditions may be present, the answer is yes and method 400 proceeds to 414. Otherwise, the answer is no and method 400 proceeds to 412.

At 412, method 400 operates inner control loop 350 of the cylinder bank that is being controlled with delta controls and base gains (e.g., proportional gains, integral gains, derivative gains, etc., where the gain values are real numbers) activated. Method 400 proceeds to 416.

At 414, method 400 adjusts controller operation. In particular, method 400 may deactivate inner control loop delta controllers (e.g., 256 of FIG. 2) for the cylinder bank that has excessive cross-talk at the current engine operating conditions (e.g., speed and load). The delta controller of the other inner control loop for a cylinder bank that does not have excessive cross-talk may remain activated. The inner loop delta controller may be deactivated by setting the output of the inner loop delta controller to a value of zero. The average controllers (e.g., 252 of FIG. 2) may remain activated.

Alternatively, instead of deactivating inner control loop delta controllers, method 400 may constrain the output authority range of inner control loop delta controllers. The delta controller's range of authority (upper & lower thresholds that are not to be crossed or exceeded) for a cylinder bank may be reduced as a function of cross-talk. Note that the delta controller's range of authority for the first and second cylinder banks may be varied independently from one another. For example, the first cylinder bank delta controller range of authority may be set to a maximum of ±15% of the mass of the base amount of fuel injected to the cylinders if the first cylinder bank cross-talk is less than 10%, then the delta fuel controller authority may be gradually reduced to ±5% of the mass of the base amount of fuel injected as cross-talk exceeds 25%, where x % cross-talk means that x % of the UEGO sensor signal comes from cylinders that the UEGO is not intended to sense.

As another alternative, method 400 may freeze operation of the delta fuel controller for the cylinder bank with excessive cross-talk. Freezing operation of the delta fuel controller includes holding output of the delta fuel controller to its present value. Additionally, internal states of the delta fuel controller are held at their present values. For example, if the delta fuel controller includes an integrator, the value of the integrator is held at its present value. Freezing operation of the delta fuel controller has the advantage that the delta fuel controller will not respond to the bias in the presence of cross-talk and delta fuel controller output learned over time may be maintained. Method 400 proceeds to 416.

At 416, method 400 operates the engine with the delta fuel controllers in their commanded states. The delta fuel controllers may adjust an amount of fuel injected to two pairs of engine cylinders if the delta fuel controller of a fuel bank is activated. The delta fuel controllers may not adjust the amount of fuel that is injected to the two pairs of engine cylinders if the delta fuel controller of the fuel bank is not activated. Method 400 proceeds to exit.

Thus, method 400 may selectively activate and deactivate delta fuel controller if oxygen sensor bias or exhaust cross-talk is determined or inferred. Deactivating or constraining the control authority range of the delta fuel controller may help to maintain engine emissions when bias or exhaust cross-talk is determined or indicated.

Thus, method 400 and at least portions of the systems shown in FIGS. 2 and 3 may provide for a method for operating an engine, comprising: via a controller, adjusting operation of an inner-loop delta fuel controller in response to an indication of oxygen sensor bias; and injecting fuel to the engine in response to output of the inner-loop delta fuel controller. In a first example, the method includes where the inner-loop delta fuel controller receives input via a first upstream oxygen sensor and a second upstream oxygen sensor, and where the indication of oxygen sensor bias is a correction value of an outer-loop fuel controller exceeding a threshold value. In a second example that may include the first example, the method further comprises generating a difference value between an output of the first upstream oxygen sensor and the second upstream oxygen sensor. In a third example that may include one or both of the first and second examples, the method further comprises subtracting a target difference value from the difference value to generate a result. In a fourth example that may include one or more of the first through third examples, the method further comprises inputting the result into the inner-loop delta fuel controller. In a fifth example that may include one or more of the first through fourth examples, the method includes where the correction value is generated via output of a downstream oxygen sensor. In a sixth example that may include one or more of the first through fifth examples, the method includes where adjusting operation of the inner-loop delta fuel controller includes deactivating the inner-loop delta fuel controller. In a seventh example that may include one or more of the first through sixth examples, the method includes where adjusting operation of the inner-loop delta fuel controller includes constraining output of the inner-loop delta fuel controller to a predetermined range.

Thus, method 400 and at least portions of the systems shown in FIGS. 2 and 3 may provide for a method for operating an engine, comprising: via a controller, adjusting operation of an inner-loop delta fuel controller in response to an indication that a first oxygen sensor in an exhaust system is being exposed to exhaust gases that have passed by a second oxygen sensor in the exhaust system; and injecting fuel to the engine in response to output of the inner-loop delta fuel controller. In a first example, the method includes where adjusting operation of the inner-loop delta fuel controller includes deactivating the inner-loop delta fuel controller. In a second example that may include the first example, the method includes where adjusting operation of the inner-loop delta fuel controller includes constraining output of the inner-loop delta fuel controller to a predetermined range. In a third example that may include one or both of the first and second examples, the method further comprises freezing output of the inner-loop delta fuel controller. In a fourth example that may include one or more of the first through third examples, the method includes where the indication is based on one or more of engine speed, engine load, cam timing, and engine exhaust back pressure.

Note that the example control and estimation routines included herein can be used with various engine and/or vehicle system configurations. In addition, although the methods included herein refer to lambda control, the approaches herein may be applied with other units. For example, the approaches herein describe lambda control, but in other examples, the controls and methods may be configured for air-fuel ratio control. The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example examples described herein, but is provided for ease of illustration and description. One or more of the illustrated actions, operations and/or functions may be repeatedly performed depending on the particular strategy being used. Further, the described actions, operations and/or functions May graphically represent code to be programmed into non-transitory memory of the computer readable storage medium in the engine control system, where the described actions are carried out by executing the instructions in a system including the various engine hardware components in combination with the electronic controller

This concludes the description. The reading of it by those skilled in the art would bring to mind many alterations and modifications without departing from the spirit and the scope of the description. For example, I3, I4, I5, V6, V8, V10, and V12 engines operating in natural gas, gasoline, diesel, or alternative fuel configurations could use the present description to advantage.

1. A fuel control system for an internal combustion engine, comprising:
a first cylinder bank coupled to an exhaust system that includes a first oxygen sensor upstream of a first catalyst and a second oxygen sensor upstream of the first catalyst; and
a controller including executable instructions stored in non-transitory memory that cause the controller to adjust operation of a first delta fuel controller that receives output from the first oxygen sensor and the second oxygen sensor in response to a first correction value of a first outer-loop fuel controller exceeding a threshold value.

2. The fuel control system of claim 1, where adjusting operation of the first delta fuel controller includes deactivating the first delta fuel controller.

3. The fuel control system of claim 1, where adjusting operation of the first delta fuel controller includes constraining output of the first delta fuel controller to a predetermined range.

4. The fuel control system of claim 1, further comprising a second cylinder bank coupled to the exhaust system, the exhaust system including a third oxygen sensor upstream of a second catalyst and a fourth oxygen sensor upstream of the second catalyst.

5. The fuel control system of claim 4, further comprising additional executable instructions stored in non-transitory memory that cause the controller to maintain operation of a second delta fuel controller in response to a second correction value of a second outer-loop fuel controller not exceeding the threshold value.

6. The fuel control system of claim 5, where the second delta fuel controller adjusts a fuel mass in response to a difference between lambda determined via the third oxygen sensor and lambda determined via the fourth oxygen sensor.

7. The fuel control system of claim 1, where the first delta fuel controller adjusts a fuel mass in response to a difference between lambda determined via the first oxygen sensor and lambda determined via the second oxygen sensor.

8. A method for operating an engine, comprising:
via a controller, adjusting operation of an inner-loop delta fuel controller in response to an indication of oxygen sensor bias; and
injecting fuel to the engine in response to output of the inner-loop delta fuel controller.

9. The method of claim 8, where the inner-loop delta fuel controller receives input via a first upstream oxygen sensor and a second upstream oxygen sensor, and where the indication of oxygen sensor bias is a correction value of an outer-loop fuel controller exceeding a threshold value.

10. The method of claim 9, further comprising generating a difference value between an output of the first upstream oxygen sensor and the second upstream oxygen sensor.

11. The method of claim 10, further comprising subtracting a target difference value from the difference value to generate a result.

12. The method of claim 11, further comprising inputting the result into the inner-loop delta fuel controller.

13. The method of claim 12, where the correction value is generated via output of a downstream oxygen sensor.

14. The method of claim 8, where adjusting operation of the inner-loop delta fuel controller includes deactivating the inner-loop delta fuel controller.

15. The method of claim 8, where adjusting operation of the inner-loop delta fuel controller includes constraining output of the inner-loop delta fuel controller to a predetermined range.

16. A method for operating an engine, comprising:
via a controller, adjusting operation of an inner-loop delta fuel controller in response to an indication that a first oxygen sensor in an exhaust system is being exposed to exhaust gases that have passed by a second oxygen sensor in the exhaust system; and
injecting fuel to the engine in response to output of the inner-loop delta fuel controller.

17. The method of claim 16, where adjusting operation of the inner-loop delta fuel controller includes deactivating the inner-loop delta fuel controller.

18. The method of claim 16, where adjusting operation of the inner-loop delta fuel controller includes constraining output of the inner-loop delta fuel controller to a predetermined range.

19. The method of claim 16, further comprising freezing output of the inner-loop delta fuel controller.

20. The method of claim 16, where the indication is based on one or more of engine speed, engine load, cam timing, and exhaust back pressure.
